(19) United States
(12) Patent Application Publication
(10) Pub. No.: US 2012/0143475 A1
(43) Pub. Date: Jun. 7, 2012

(54) FUEL SUPPLY SYSTEM FOR GDI ENGINE AND CONTROL METHOD THEREOF

(75) Inventors: Dongmyoung RYOO, Yongin-si (KR); Buyeol Ryu, Hwaseong-si (KR); Pilseon Choi, Suwon-si (KR)

(73) Assignees: KIA MOTORS CORPORATION, Seoul (KR); HYUNDAI MOTOR COMPANY, Seoul (KR)

(21) Appl. No.: 13/299,161

(22) Filed: Nov. 17, 2011

(30) Foreign Application Priority Data
Dec. 1, 2010 (KR) 10-2010-0121514

(51) Int. Cl. F02D 41/30; F02D 41/26

(52) U.S. Cl. 701/103

(57) ABSTRACT

A fuel supply system for a Gasoline Direct Injection (GDI) engine may include an Engine Control Unit (ECU) that sets a desired fuel pressure and controls a fuel pressure of a section from a low-pressure fuel pump to a high-pressure fuel pump in accordance with the desired fuel pressure, and a fuel pressure sensor that measures the fuel pressure of the section from the low-pressure fuel pump to the high-pressure fuel pump and supplies the measured fuel pressure to the ECU for feedback-controls of the low-pressure fuel pump. The fuel supply system may further include a fuel pump controller disposed between the ECU and the low-pressure fuel pump to control the low-pressure fuel pump. A control method of the fuel supply system may include detecting the number of revolution of the engine and the load, setting the desired fuel pressure, and feedback controlling the low-pressure pump.

### CROSS-REFERENCE TO RELATED APPLICATIONS

The present application claims priority of Korean Patent Application Number 10-2010-0121514 filed Dec. 1, 2010, the entire contents of which application are incorporated herein for all purposes by this reference.

### BACKGROUND OF INVENTION

1. Field of Invention

The present invention relates to a fuel supply system for a Gasoline Direct Injection (GDI) engine and a control method thereof, and more particularly, to a technology of controlling fuel pressure in a section from a low-pressure fuel pump to a high-pressure fuel pump.

2. Description of Related Art

GDI engines are gasoline engines that directly inject fuel into a combustion chamber, in which fuel supplied from a low-pressure fuel pump in a fuel tank is increased in pressure by a high-pressure fuel pump and then supplied to an injector, in order for the fuel to be directly injected into the combustion chamber.

The low-pressure fuel pump of the related art is not specifically controlled, but is supplied with electricity from a battery and pumps up fuel while operating always in accordance with the maximum amount of fuel consumption, such that a large amount of power is consumed and durability is decreased.

Further, at a high fuel temperature, for example 100° C. or above, pumping by the high-pressure fuel pump is not appropriately made by evaporation of the fuel, such that there is a problem in starting the engine at high temperature. In this case, although it is possible to solve the problem by increasing the fuel pressure in the low-pressure fuel pump, it is impossible to control the fuel pressure at the present time.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention are directed to provide a fuel supply system for a Gasoline Direct Injection (GDI) engine that improves fuel efficiency of a vehicle with minimum power that is consumed by the low-pressure fuel pump, durability of the low-pressure fuel pump, and start performance at high temperature, by making it possible to appropriately control fuel pressure between a low-pressure fuel pump and a high-pressure fuel pump, which supply fuel to the GDI engine, in accordance with the state of the engine.

Other various aspects of the present invention are directed to provide a control method for controlling the fuel supply system.

One aspect of the present invention is directed to provide exemplary fuel supply systems for a GDI engine, including an Engine Control Unit (ECU) that sets a desired fuel pressure and controls a fuel pressure of a section from a low-pressure fuel pump to a high-pressure fuel pump in accordance with the desired fuel pressure, the low-pressure fuel pump that is controlled by the ECU, and a fuel pressure sensor that measures the fuel pressure of the section from the low-pressure fuel pump to the high-pressure fuel pump and supplies the measured fuel pressure to the ECU, wherein the ECU feedback-controls the low-pressure fuel pump in response to a signal from the fuel pressure sensor.

Exemplary fuel supply systems for a GDI engine may further include a fuel pump controller that controls the low-pressure fuel pump in response to a control signal from the ECU, the fuel pump controller disposed between the ECU and the low-pressure fuel pump.

The low-pressure fuel pump in the exemplary fuel supply systems may be operated by a Brushless DC (BLDC) motor, and the fuel pump controller may include a Car Area Network Micro Control Unit (CAN MCU) that receives a control duty from the ECU and sends out a diagnosis signal to the ECU and a Brushless DC Micro Control Unit (BLDC MCU) that receives the control duty from the CAN MCU and controls the BLDC motor.

The ECU in the exemplary fuel supply systems may be receive a signal from the fuel pressure sensor through the fuel pump controller.

Another aspect of the present invention is directed to provide exemplary control methods of a fuel supply system for a GDI engine, the method including detecting a number of revolution of the engine and a load, selecting a fuel pressure from a pre-stored map of fuel pressure in accordance with the number of revolution of the engine and the load, and setting the fuel pressure as the desired fuel pressure for the low-pressure fuel pump, and feedback controlling the low-pressure pump by comparing the fuel pressure inputted from the fuel pressure sensor with the desired fuel pressure and controlling the low-pressure pump in accordance with a comparing result.

Yet another aspect of the present invention is directed to provide exemplary control methods of a fuel supply system for a GDI engine, the method including setting the desired fuel pressure for the low-pressure fuel pump in accordance with operational conditions of the engine, and feedback controlling the low-pressure pump by comparing the fuel pressure inputted form the fuel pressure sensor with the desired fuel pressure and controlling the low-pressure pump in accordance with a comparing result.

The desired fuel pressure for the low-pressure fuel pump in the exemplary control methods may be set by a fuel temperature at a front end of the high-pressure fuel pump when the engine is started, and the higher the fuel temperature, the higher the desired fuel pressure is set.

The operational conditions of the engine for setting the desired fuel pressure for the low-pressure fuel pump in the exemplary control methods may include starting at high temperature, idling, traveling, and accelerating.

According to the exemplary fuel supply systems and methods of the present invention, it is possible to improve fuel efficiency of a vehicle with minimum power that is consumed by the low-pressure fuel pump, durability of the low-pressure fuel pump, and start performance at high temperature, by making it possible to appropriately control fuel pressure between a low-pressure fuel pump and a high-pressure fuel pump, which supply fuel to a GDI engine, in accordance with the state of the engine.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating an exemplary fuel supply system for a GDI engine according to the present invention.

FIG. 2 is a view showing another exemplary fuel supply system for a GDI engine according to the present invention.

FIG. 3 is a flowchart illustrating an exemplary control method of a fuel supply system for a GDI engine according to the present invention.

FIG. 4 is a diagram showing an example of a map of fuel pressure according to the number of revolution of an engine and load that are used in the exemplary control method shown in FIG. 3.

FIG. 5 shows exemplary settings for the desired fuel pressure in accordance with the operational conditions of the engine according to the present invention.

FIG. 6 shows yet another exemplary fuel supply system modified from FIG. 1.

FIG. 7 shows still yet another exemplary fuel supply system modified from FIG. 2

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

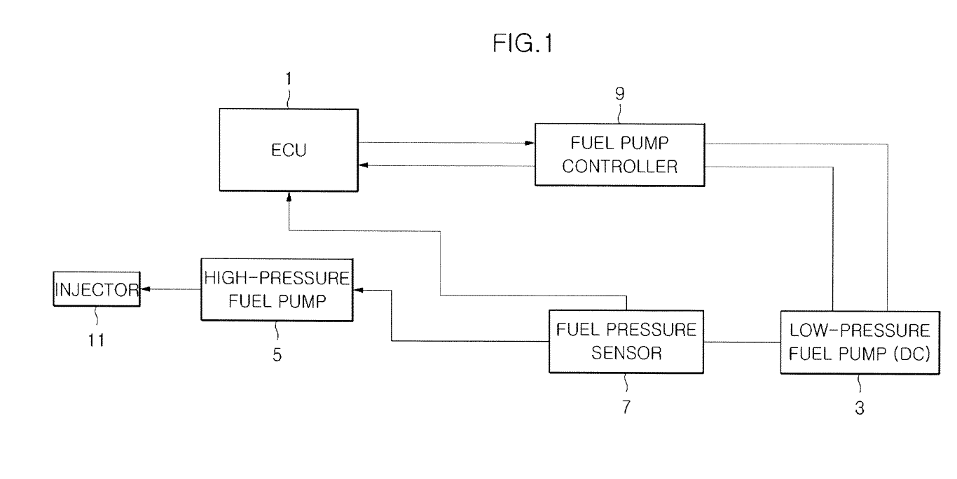

Referring to FIG. 1, various embodiments of the present invention include an Engine Control Unit (ECU) 1 that sets desired fuel pressure and controls the fuel pressure of the section from a low-pressure fuel pump to a high-pressure fuel pump in accordance with the desired pressure, a low-pressure pump 3 that is controlled by the ECU 1, and a fuel pressure sensor 7 that measures the fuel pressure of the section from low-pressure fuel pump 3 and a high-pressure fuel pump 5 and supplies the measured result to ECU 1.

A fuel pump controller 9 that controls low-pressure fuel pump 3 in response to a control signal from ECU 1 is disposed between ECU 1 and low-pressure fuel pump 3.

That is, ECU 1 controls low-pressure fuel pump 3, not directly, but through fuel pump controller 9 and supplies a signal for feedback-controlling low-pressure fuel pump 3 in response to a signal from fuel pressure sensor 7, to fuel pump controller 9.

ECU 1 outputs control duty to fuel pump controller 9 through a Car Area Network (CAN) to estimate the desired fuel pressure and receives information on breakdown diagnosis through the CAN from fuel pump controller 9 to store a breakdown code and turn on/off an engine alarm light.

Obviously, the fuel pumped up by low-pressure fuel pump 3 is supplied to an injector 11 through high-pressure fuel pump 5.

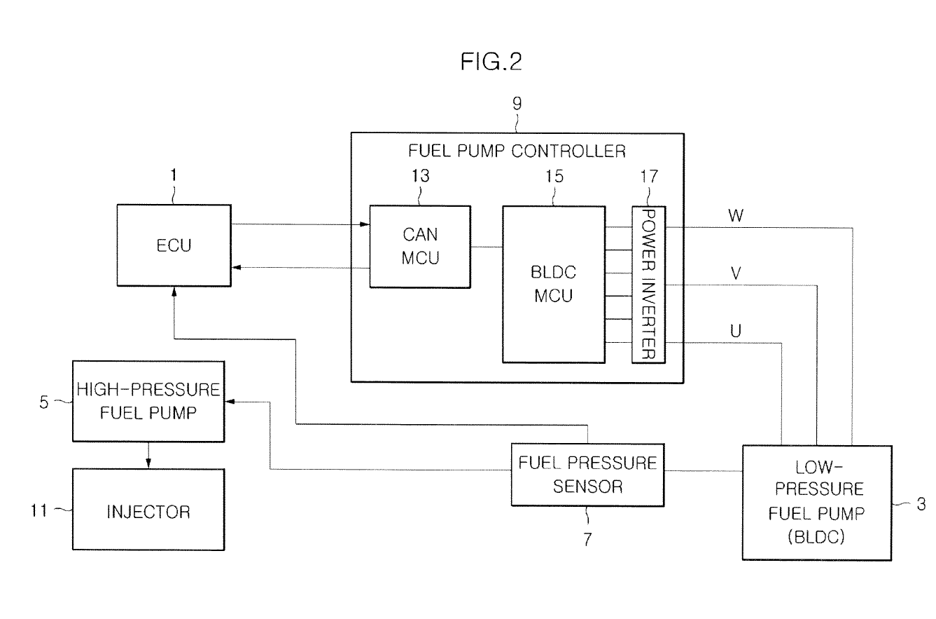

FIG. 2 illustrates other embodiments of the present invention, in which although the other configurations are the same, low-pressure fuel pump 3 is a Brushless DC (BLDC) fuel pump that is operated by a BLDC motor and fuel pump controller 9 includes a Car Area Network Micro Control Unit (CAN MCU) 13 that receives the control duty from ECU 1 and sends out a diagnosis signal to ECU 1 and a Brushless DC Micro Control Unit (BLDC MCU) 15 that receives the control duty from the CAN MCU and controls the BLDC motor.

Further, the BLDC MCU controls low-pressure fuel pump 3 by duty-controlling three-phase power through a power inverter 17.

The BLDC motor increases efficiency of the fuel pump by the operational characteristics, such that it is possible to further reduce the power consumed by low-pressure fuel pump 3.

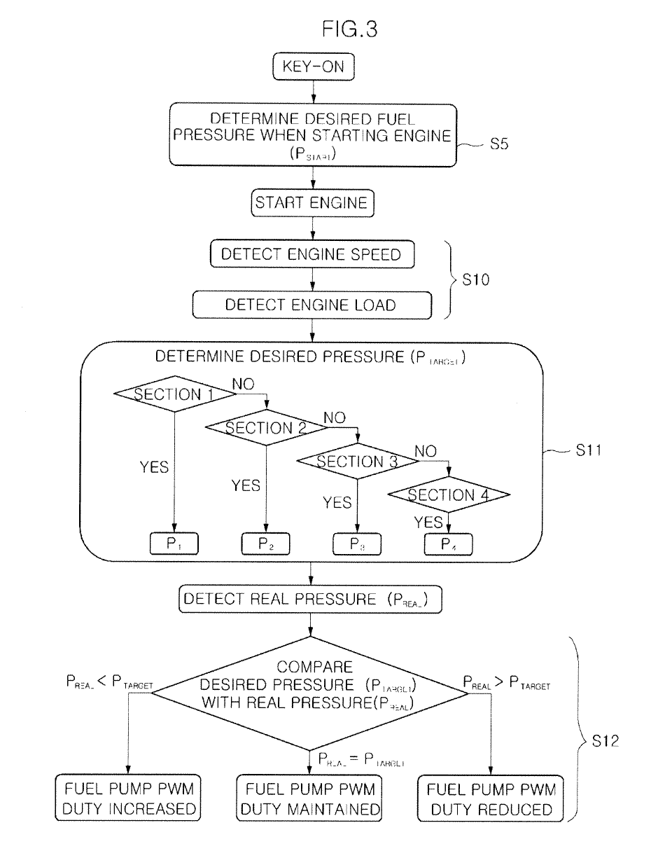

A method of controlling the fuel supply systems for a GDI engine according to various embodiments of the present invention, which are shown in FIGS. 1 and 2, is described hereafter with reference to FIG. 3.

Referring to FIG. 3, an exemplary control method according to the present invention includes detecting load of an engine and the number of revolution of the engine (S10), selecting fuel pressure corresponding to the load and the number of revolution of the engine that are measured from a map of fuel pressure according to the number of revolution of an engine and load, which are memorized in advance, and setting the selected fuel pressure to desired fuel pressure for low-pressure fuel pump 3 (S11), and feedback controlling that compares fuel pressure inputted from fuel pressure sensor 7 with the desired fuel pressure and controls low-pressure pump 3 in accordance with the comparing result (S12).

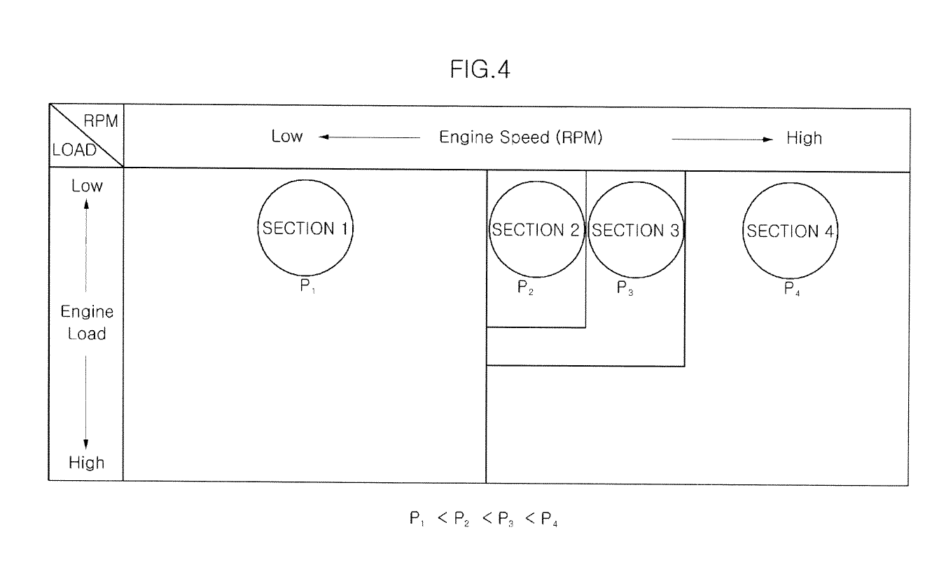

That is, ECU 1 receives the number of revolution of an engine and load, selects fuel pressure corresponding number of revolution of an engine and load from a map that is inputted in advance and shown in FIG. 4, sets the fuel pressure as desired pressure such that low-pressure pump 3 is operated in accordance with the desired fuel pressure. Accordingly, low-pressure fuel pump 3 operates at a different operational speed in accordance with the number of revolution of an engine and load, unlike the related art, such that power unnecessarily consumed is minimized and appropriate fuel pressure for the state of the engine is achieved.

Information on the number of revolution of an engine can be acquired from the engine speed sensor and the load of the engine can be acquired from a Throttle Position Sensor (TPS) signal or an Indicated Mean Effective Pressure (IMEP).

On the other hand, control is made different before and after starting the engine in the exemplary embodiment shown in FIG. 3, in which the control according to the number of revolution of an engine and load is made as described above after the engine is started, while desire fuel pressure for low-pressure fuel pump 3 is set in accordance with fuel temperature at the front end of high-pressure fuel pump 5 (S5) and low-pressure fuel pump 3 is feedback-controlled, when the engine is started.

That is, in order to improve starting performance at high temperature, it is possible to allow the high-pressure fuel pump to smoothly pump the fuel by preventing the fuel from evaporating, by allowing low-pressure fuel pump 3 to transport the fuel at high pressure corresponding to when the fuel temperature at the front end of the high-pressure fuel pump is high.

Obviously, the higher the temperature of the fuel, the higher the desired fuel pressure is set.

As another exemplary method of controlling a fuel supply system for a GDI engine, which was described above, the method sets desired fuel pressure for low-pressure fuel pump 3 in accordance with the operational conditions of an engine.

That is, since the load that low-pressure fuel pump 3 substantially carries depends on the operational conditions of the engine, such as starting at high pressure, idling, traveling, and accelerating, the method appropriately operates low-pressure fuel pump 3 by setting the desired fuel pressure in accordance with the operational conditions of the engine and controls low-pressure fuel pump 3 at the desired fuel pressure.

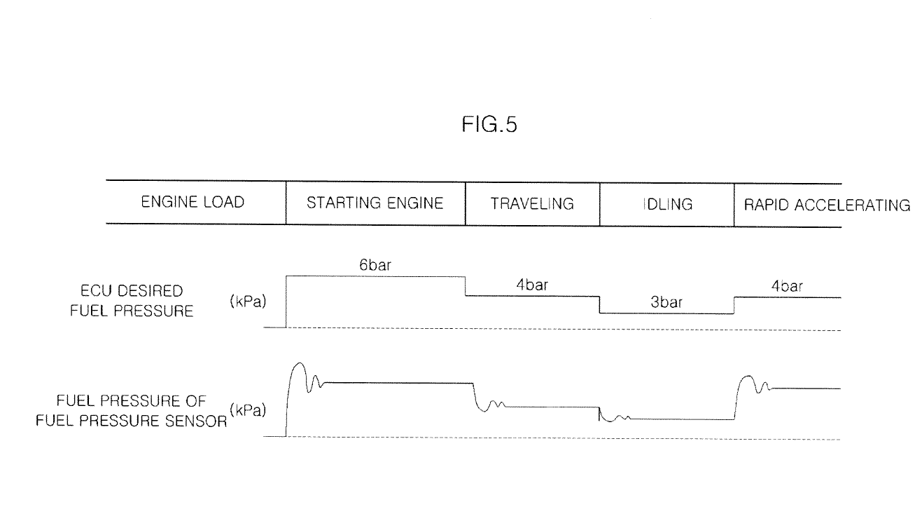

The fuel pressure is high and the amount of fuel consumption is small, when the operational condition of the engine is the starting at high temperature, the fuel pressure is low and the amount of fuel consumption is small in the idling, the fuel pressure and the amount of fuel consumption are at a middle level in normal traveling, and the fuel pressure is at a middle level but the amount of fuel consumption is large in accelerating. Accordingly, ECU 1 sets the desired fuel pressure in accordance with the operational conditions of the engine, as shown in FIG. 5.

For reference, in addition to an example of desired fuel pressure for each operational condition described above, fuel pressure for low-pressure fuel pump 3 measured by fuel pressure sensor 7 is shown in FIG. 5.

Obviously, in various embodiments, as described above, when the desired fuel pressure is set, feedback control that compares the fuel pressure inputted from fuel pressure sensor 7 with the desired fuel pressure and controls low-pressure fuel pump 3 in accordance with the comparing result is performed.

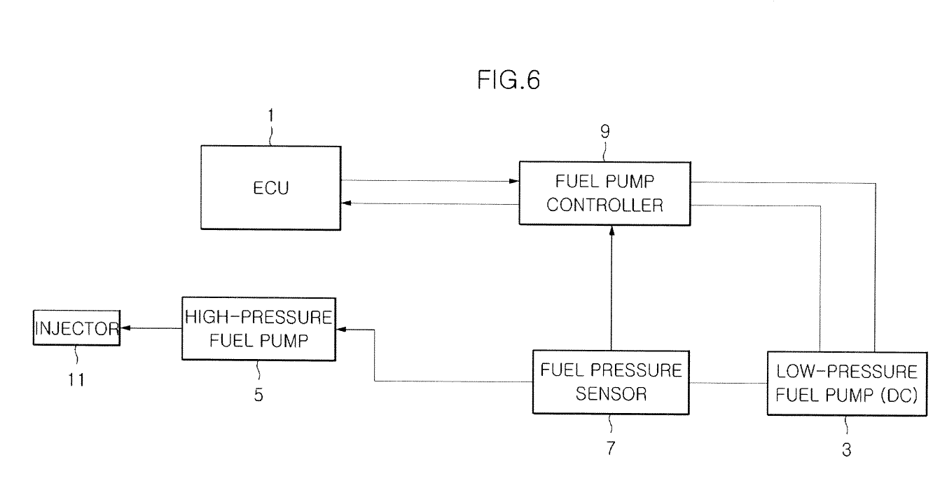

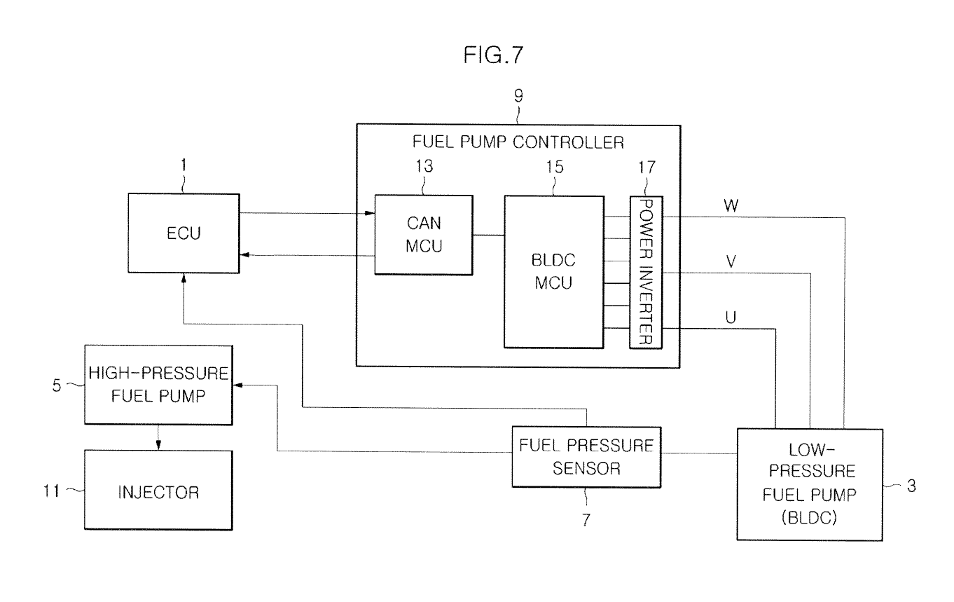

FIGS. 6 and 7 are modified embodiments of FIGS. 1 and 2, respectively, which have almost the same configuration, except that the sensing signal of fuel pressure sensor 7 is directly supplied to fuel pump controller 9.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel supply system for a Gasoline Direct Injection (GDI) engine, comprising:
an Engine Control Unit (ECU) that sets a desired fuel pressure and controls a fuel pressure of a section from a low-pressure fuel pump to a high-pressure fuel pump in accordance with the desired fuel pressure;
the low-pressure fuel pump that is controlled by the ECU; and
a fuel pressure sensor that measures the fuel pressure of the section from the low-pressure fuel pump to the high-pressure fuel pump and supplies the measured fuel pressure to the ECU,
wherein the ECU feedback-controls the low-pressure fuel pump in response to a signal from the fuel pressure sensor.

2. The fuel supply system for a GDI engine as defined in claim 1, further comprising a fuel pump controller that controls the low-pressure fuel pump in response to a control signal from the ECU, the fuel pump controller disposed between the ECU and the low-pressure fuel pump.

3. The fuel supply system for a GDI engine as defined in claim 2, wherein the low-pressure fuel pump is operated by a Brushless DC (BLDC) motor, and the fuel pump controller includes a Car Area Network Micro Control Unit (CAN MCU) that receives a control duty from the ECU and sends out a diagnosis signal to the ECU and a Brushless DC Micro Control Unit (BLDC MCU) that receives the control duty from the CAN MCU and controls the BLDC motor.

4. The fuel supply system for a GDI engine as defined in claim 2, wherein the ECU receives a signal from the fuel pressure sensor through the fuel pump controller.

5. A control method of the fuel supply system as defined in claim 1, the method comprising:
detecting a number of revolution of the engine and a load;
selecting a fuel pressure from a pre-stored map of fuel pressure in accordance with the number of revolution of the engine and the load, and setting the fuel pressure as the desired fuel pressure for the low-pressure fuel pump; and
feedback controlling the low-pressure pump by comparing the fuel pressure inputted from the fuel pressure sensor with the desired fuel pressure and controlling the low-pressure pump in accordance with a comparing result.

6. The control method as defined in claim 5, wherein the desired fuel pressure for the low-pressure fuel pump is set in accordance with a fuel temperature at a front end of the high-pressure fuel pump when the engine is started, and the higher the fuel temperature, the higher the desired fuel pressure is set.

7. A control method of the fuel supply system as defined in claim 1, the method comprising:
setting the desired fuel pressure for the low-pressure fuel pump in accordance with operational conditions of the engine; and
feedback controlling the low-pressure pump by comparing the fuel pressure inputted form the fuel pressure sensor with the desired fuel pressure and controlling the low-pressure pump in accordance with a comparing result.

8. The control method as defined in claim 7, wherein the operational conditions of the engine for setting the desired fuel pressure for the low-pressure fuel pump include starting at high temperature, idling, traveling, and accelerating.
